(19) United States
(12) Patent Application Publication
(10) Pub. No.: US 2014/0067694 A1
(43) Pub. Date: Mar. 6, 2014

(54) Method for planning and managing maintenance, repair and overhaul work, a computer software product, a digital storage medium, a terminal, a system for planning and managing, and a communications interface

(71) Applicants: Airberlin Technik GmbH, Berlin (DE); Fraunhofer-Gesellschaft zur Foerderung der angewandten Forschung e. V., Munich (DE)

(72) Inventors: Frank Moos, Berlin (DE); Thomas Knothe, Berlin (DE)

(73) Assignees: Airberlin Technik GmbH, Berlin (DE); Fraunhofer-Gesellschaft zur Foerderung der angewandten Forschung e.V., Munich (DE)

(21) Appl. No.: 13/962,500

(22) Filed: Aug. 8, 2013

Related U.S. Application Data
(60) Provisional application No. 61/680,881, filed on Aug. 8, 2012.

(30) Foreign Application Priority Data
Aug. 8, 2012 (DE) 10 2012 214 106.5

(51) Int. Cl. G06Q 10/00

(52) U.S. Cl. CPC G06Q 10/20
USPC 705/305

(57) ABSTRACT

The invention relates to a method (3000, 4000) for planning and managing maintenance, repair and overhaul work on a vehicle of a transportation system comprising a network which includes the following network components:
at least one vehicle 202,
a log book 202E, 549 assigned to the at least one vehicle 202,
accessories 203, 204, 541, 543, 546,
at least one first terminal 203E, 204E, 542, 544, 547 assigned to the accessories,
at least one second terminal 203E, 204E, 542, 544, 547 assigned to the accessories,
   said method comprising the steps of:
e) transmitting data defining accessory needs from the log book 202E, 549 into the network,
f) receiving the data at the first and the second terminal 203E, 204E, 542, 544, 547,
g) bidirectional communication among the network components,
h) assigning the maintenance, repair and overhaul work,
i) providing feedback after completion of the maintenance, repair and overhaul work,
   wherein said assigning and said providing of feedback are performed by at least one of the network components.

The invention relates to a method according to the preamble of claim 1. The invention also relates to a computer software product according to the preamble of claim 9. The invention further relates to a digital storage medium and to a terminal for attachment to accessories of a transportation system. The invention also relates to a system according to the preamble of claim 13. The invention further relates to a communications interface for exchanging data.

Due to high loads and in some cases to tough official requirements, vehicles in a transportation system are governed by a defined schedule for maintenance, repair and overhaul. Such a maintenance, repair and overhaul schedule generally includes the maintenance, repair and overhaul work to be carried out, such as inspection, maintenance, repair and modification of the vehicles. Planning and managing such maintenance, repair and overhaul work for transportation systems comprising many individual vehicles that move between several maintenance locations, as in the case of aircraft or railways, for example, is very complicated.

Such maintenance, repair and overhaul work involves many different tasks that can vary in type and duration. Tasks ranging from short repair jobs to the complete taking apart and re-assembly of the entire vehicle may be involved in this regard, as may both scheduled and unscheduled maintenance, repair and overhaul work. Some of the maintenance, repair and overhaul work may also have to comply with official requirements. In the case of aircraft, in particular commercial aircraft, all maintenance, repair and overhaul work according to a maintenance, repair and overhaul program predefined by the manufacturer is adapted to the usage profile and is subsequently checked and approved by an authority. Various “letter checks” are carried out, for example a “D-check”, which is equivalent to a major overhaul and involves intensive, long and costly maintenance, repair and overhaul work. Depending on the type of aircraft, such a D-check is carried out after several thousand flying hours.

In the case of high-speed trains, such as the ICE trains in Germany, short inspection intervals are imperative due to the high speeds and high concomitant stresses that are involved. A “safety inspection” must be carried out here after about 8,000 vehicle miles in operation. Any outage of vehicles due to such inspections causes a substantial amount of expense. In the case of intensive and/or frequently necessary inspections, it is therefore essential that such inspections be carried out within the shortest possible time. Scheduled and unscheduled maintenance, repair and overhaul work must be assigned to the respective personnel, and steps must be taken to ensure that spare parts and the requisite tools are provided.

In addition to such maintenance, repair and overhaul work, the availability of the vehicle in a transportation system must be scheduled using a defined resource planning system. The maintenance, repair and overhaul work must be synchronized with the deployment schedule for the vehicles in the respective transportation system. The availability of transportation systems can thus be reduced not only by the maintenance, repair and overhaul work (also abbreviated to “MRO”), by also by insufficient planning and management. Scheduled and unscheduled MRO tasks must be assigned to mechanics, and steps must be taken to ensure that spare parts and the requisite tools are provided, which can sometimes be very expensive. MRO work must also be synchronized with the resource planning of the transportation system.

Management of maintenance, repair and overhaul work is affected by various factors. First, additional malfunctions in, or damage to a vehicle in the transportation system may be discovered at any time, remedy of which will alter the initial MRO schedule. Such damage occurs when an aircraft is hit by a “birdstrike”, for example. What can also happen is that the vehicle of the transportation system does not arrive at the maintenance location at the agreed time due to unforeseen factors, such as bad weather. Furthermore, the accessories needed to carry out the maintenance, repair and overhaul work may be affected by unforeseen factors, with the result that scheduled maintenance, repair and overhaul work (MRO work) cannot be carried out at all, or cannot be carried out at the intended maintenance location. Other factors may include altered usage intensity due to changes in market conditions, strong seasonal fluctuations or changes in destination regions (e.g., use in the tropics, deserts, polar regions or regions with volcanic activity).

For this reason, a basic problem that arises is that decentralized identification of MRO needs, in other words the material and equipment needed for the respective maintenance, repair and overhaul work, must be planned and managed at different maintenance locations for different vehicles of the transportation system, separately from decentralized processing, and by taking into consideration a centralized transport schedule and unforeseen events. This requires the synchronization of human resources, spare parts and tools at decentralized locations.

However, the prior art includes only planning and management processes that run sequentially and with unnecessary loops and many unnecessary interfaces from the planning department through to the personnel carrying out such processes. The various maintenance locations, and the scheduled and unscheduled work according to the loads imposed on the vehicles, can be coordinated with each other to an inadequate extent only, with the result, for example, that certain spare parts, tools and transport devices as well as specifically skilled personnel are available at particular maintenance locations only. If unscheduled work must be carried out because of malfunctions, this will therefore require additional and costly maintenance operations, or cancellations. Such processes are supported by specially engineered software systems, such as TRAX, AMOS and others. These systems take individual sets of diagnostic data as well as load data of the vehicles into account during the planning process. Multiple redundancies in the capturing and keeping of data, as well as media and information discontinuities, occur in such processes and software systems and reduce the performance of processes. Such complexity, and other factors, make it more difficult for operators of air traffic systems to assign and process individual maintenance tasks, included in time-consuming letter checks, on an individual basis along narrow maintenance slots within the flight schedule. This assignment would reduce protracted idle times during the checks and in addition would also simplify certain workflows.

A principle is known from the article by Sampigethaya et al., entitled “Future E-Enabled Aircraft Communications and Security: The Next Twenty Years and Beyond”, accepted, in Proceedings of the IEEE, Special Issue on Aerospace Communications and Networking in the Next Two Decades, (December, 2011), with which direct communication is meant to function between aircraft and a “Cyber-Physical System” (CPS) that has been extended by a maintenance infrastructure. A CPS is understood here to be a system that includes various mobile and embedded devices that are adapted to connect and coordinate computer elements and physical elements of a system. The document relates primarily to the security of networks and to communications infrastructures.

What would be desirable would be a system for planning and managing, without any unnecessary redundancy in data capturing or data retention, and without any media or information discontinuities, such that the process performance is reduced as little as possible or only slightly, and/or that the planning of maintenance, repair and overhaul work is facilitated in any case for large transportation systems, in particular.

Linking diagnostic data and anticipative maintenance is known from the article by Lee et al. entitled “Intelligent Maintenance Systems: The Next Five Years and Beyond—Transforming Condition-based Maintenance to Productivity and Service Innovation”, in Asset Management and Maintenance Journal, July 2010. pp. 6-13. Additional systems are needed that involve manual effort, despite the partial integration of data. As a consequence, such linking cannot be used if boundary conditions are more complex, as in aviation or in rail systems.

“Integrated Product-Service” systems (IPS systems) which support maintenance, repair and overhaul work by creating work orders, ordering materials, up to and including the providing of feedback, are known from the prior art. Work orders and reports usually require status input to be done manually. Based on information received by applying predefined rules, a planning schedule is generated. The rules basically consist of a flow chart containing conditions for implementation and for that reason are not particularly adaptive. Furthermore, the work schedules are produced manually as a rule and can only be adapted with considerable extra effort. Agility in performing maintenance, repair and overhaul work is desirable, but is inhibited as a consequence.

A reference architecture with which business processes, human resources, aircraft and information can basically be strategically linked and integrated is known from the “Boeing eEnabled Solution” developed by Boeing, the aircraft manufacturer. However, the planning and managing processes also have numerous unnecessary interfaces, from the planning department through to the personnel performing the work, so these processes remain complex and time-consuming.

Such an approach is unable to facilitate the planning and managing of maintenance, repair and overhaul work for transportation systems comprising many individual vehicles that move between several maintenance locations. High redundancy levels and many unnecessary interfaces result in substantial effort and expense, as well as unnecessary idle time on the part of tools, spare parts or the vehicles themselves, thus causing additional and substantial costs.

It is desirable to specify a method and a system for planning and managing maintenance, repair and overhaul work on a vehicle of a transportation system, that is improved with regard to the prevention of redundancies and idle times of tools, spare parts or personnel.

This is addressed by the invention, the object of which is to specify a method and a system by means of which the planning and management of maintenance, repair and overhaul work on a vehicle of a transportation system can be improved. The aim, more specifically, is to reduce the idle times of spare parts, tools and vehicles.

This object is achieved, as far as the method is concerned, by a method of the kind initially specified, in which the inventive features in the characterizing portion of claim 1 are provided. The object is achieved, as far as the system is concerned, by a system of the kind initially specified, in which the inventive features in the characterizing portion of claim 13 are provided.

The concept of the invention is based on an approach for planning and managing maintenance, repair and overhaul work on a vehicle of a transportation system comprising a network which includes the following network components: at least one vehicle, a log book assigned to the at least one vehicle, accessories, at least one first terminal assigned to the accessories and at least one second terminal assigned to the accessories.

The accessories are preferably a tool, a transporter unit, a spare part and/or a person performing maintenance work, in particular a worker. Accessories, it should be understood, specifically include spare parts and, more specifically, cost-intensive tools. A particularly preferred variant is one in which a first terminal can be assigned to a tool and/or a further first terminal can be assigned to a transporter unit and/or the second terminal can be assigned to a spare part and/or a third terminal can be assigned to a person performing maintenance work, in particular a worker.

According to the invention, the following steps are performed:

a) transmitting data defining accessory needs from the log book into the network,
b) receiving the data at the first and the second terminal,
c) bidirectional communication among the network components,
d) assigning the maintenance, repair and overhaul work,
e) providing feedback after completion of the maintenance, repair and overhaul work,
wherein said assigning and said providing of feedback are performed by at least one of the network components.

The concept of the invention assumes, in particular, that the first and the second terminal provided on an accessory—e.g. on a tool, a transporter unit, a spare part and/or on a person performing maintenance work, in particular on a worker—receives the data defining accessory needs that are transmitted for information management purposes from a log book of the vehicle of the transportation system, in particular from an electronic network-ready log book. The log book communicates with the first and/or second terminal provided on the accessories and/or the first terminal provided on the accessory communicates with the second terminal. The maintenance, repair and overhaul work is assigned by means of the log book and/or by the first and/or second terminal. The feedback to the log book about the work completed is sent by the first and/or second terminal.

It is particularly preferred that the bidirectional communication includes negotiation among the network components and further comprises the step of:

c′) alert management when said bidirectional negotiation is unsuccessful. If, for example, essential spare parts, tools, building features, approvals or mechanics/skills are unavailable, the electronic log book negotiates decentrally, taking into account the time frames for maintenance, repair and overhaul that are determined by the flight or travel schedule and by the deadline rules of the vehicle system. Transportation of spare parts or tools from one location to the site performing the maintenance work are planned and assigned by the electronic log book by comparing and co-ordinating with a central monitoring system.

One further developed method includes steps a) to e), and step c′) in particular, and can prompt the performance of these steps via a communications interface, in particular in that the steps are performed sequentially, preferably in a loop.

The concept of the invention is based on the idea that the data defining accessory needs—in particular a tool, a transporter unit, a spare part, or also, where relevant, a person performing maintenance work, in particular a worker—are transmitted from a log book of the transportation system vehicle, in particular from an electronic log book, for information management, in particular from an electronic flight bag (EFB) provided in an aircraft, and/or from a terminal provided on a component of the transportation system vehicle. Such a log book specifically includes a position detection means so that it can determine its own position, a radio communication link, a negotiating component for negotiating with a terminal, a fault tree system, a data storage, an electronic data interface, a means of transforming data, a user interface such as an input mask and/or a task planner. The data defining the accessory needs—at least one spare part and a tool—specifically include not only the maintenance schedule of the respective vehicle, but also unforeseen malfunctions of, and/or damage to the vehicle. The needs of the accessories are determined from these data and are forwarded directly from the vehicle to the terminals provided on the accessories. The expression “accessories” specifically includes tools, spare parts, transport devices and/or personnel.

The first and/or second terminal provided on the accessories specifically receives information via an input channel and/or transmits control signals via an output channel. The information received via the input channel is stored in a storage unit of the terminal and is processed using a processing unit of the terminal. It is advantageous that the first terminal can communicate bidirectionally, i.e., exchange and compare information, with the second terminal, and/or that the log book can communicate bidirectionally with the first and/or second terminal as a result. The communication occurs in such a way, in particular, that the network components operate semantically and/or with a tree structure.

It is advantageous that the concept does not depend on a roundabout way of transmitting the data to a central location that then forwards the data to the accessories—for example to a spare part and/or to a tool or a transporter unit. The invention is based on the realization that direct transmission of the data by the system shortens the number of steps in the process. In order to further reduce the number of steps and to simplify process handling, the concept also includes the log book and/or the terminal provided on a component of the vehicle of the transportation system communicating with the terminals provided on the accessories, and/or the terminals provided on the accessories communicating among each other. The terminal is embodied, in particular, as a miniaturized computer such as an “eGrain” and/or as an “RFID system” (“radio-frequency identification”). These are provided for determining its own position, for radio linkage and for route assignment purposes. They also have a negotiating component in order to process received data autonomously and to give feedback to the system transmitting the data. For example, information about a defective screw in an aircraft door is sent, during flight, directly from the aircraft to the mechanic who is to remedy the problem, and to the tool which is required. The tool and the mechanic are then ready at the right location at soon as the aircraft has landed. Once the mechanic has solved the problem, the aircraft receives direct feedback that the work has been completed.

The invention includes the realization that the planning and managing processes can be simplified by the system directly assigning the maintenance, repair and overhaul work and by direct feedback being given when the maintenance, repair and overhaul work has been completed.

The concept of the invention also includes a computer software product according to claim 9 for planning and managing maintenance, repair and overhaul work for transportation systems comprising a network which includes the following network components: at least one vehicle, a log book assigned to the at least one vehicle, accessories, at least one first terminal assigned to the accessories and at least one second terminal assigned to the accessories, the computer software product being designed to be loaded into a storage unit of at least one network component and having portions of software code, by means of which the computer software product is designed to perform the steps of the method according to any of the preceding claims when it runs on a processing unit of the network component. The computer software product is preferably loaded into a storage unit of the first and/or second terminal provided on the accessory. It has been found, as a result, that the maintenance, repair and overhaul work can be assigned advantageously by the system.

The concept of the invention also includes a digital storage medium according to claim 10, in particular an electronic, optical and/or magnetic storage medium containing electronically readable computer-implemented instructions which can interact with a programmable computer system in such a way that a method according to the invention is performed. Such a digital storage medium is selected in particular from a group comprising storage cards, diskettes and CDs.

The concept of the invention also includes a terminal designed for being attached to accessories of a transportation system comprising a network, wherein the terminal is provided as a component of the network. According to the invention, the terminal comprises:
an input channel for receiving information,
an output channel for transmitting a control signal,
a storage unit for storing the information,
a processing unit for processing the computer software product according to the invention, and
a communications protocol for defining the syntax, the semantics and the synchronization of communication with other network components,
   wherein the terminal is configured for bidirectional communication with the other network components.

Such a terminal is designed specifically as a highly miniaturized computer such as an “eGrain”, and/or as an RFID system (“radio-frequency identification”). The terminal is provided, in particular, on an accessory, in particular on a tool, a spare parts, a transport device or on a portable device carried by the respective personnel, for example on a tablet PC. The terminal is designed, in particular, to communicate maintenance, repair and overhaul work with other terminals and/or to a log book provided in a vehicle, in particular to an electronic flight bag (EFB) provided on an aircraft.

The concept of the invention also includes a system for planning and managing maintenance, repair and overhaul work on a vehicle of a transportation system comprising a network. According to the invention, the former system comprises:
a central system for capacity planning, for presenting the data, for resource planning and/or for escalation management,
network components of the transportation system network, including:
   at least one vehicle,
   a log book assigned to the at least one vehicle,
   accessories,
   at least one first terminal provided on the accessories,
   at least one second terminal provided on the accessories,
a communications interface for exchanging data between the central system and the network components, at least,
   wherein at least one of the network components is configured to assign the maintenance, repair and overhaul work and to provide feedback after completion of the maintenance, repair and overhaul work.

It is further preferred that the network components of the transportation system network further include:
at least one defined maintenance location with certified maintenance scope and/or maintenance capacity; and/or
a person performing maintenance work, having predefined maintenance skills and/or maintenance capacity and assigned in particular to a maintenance location.

The communications interface is provided, in particular, for the exchange of data between the central system and the log book and/or a first and/or second terminal, and/or between the log book and/or a first and/or second terminal and/or between the first terminal and the second terminal. The log book is prepared, in particular, for assigning maintenance, repair and overhaul work to at least one first and/or second terminal provided on the accessories and/or the first and/or second terminal provided on the accessories is prepared for giving feedback, for example feedback to the log book about the work that has been completed.

The concept of the invention advantageously realizes that the task workflow can be simplified and the number of administrative steps can be shortened by the system assigning the maintenance, repair and overhaul work to a vehicle of a transportation system and by feedback being given about the maintenance, repair and overhaul work. In the case of an aircraft fleet, for example, a mechanic is commissioned directly in real time by the aircraft. This is supported by an integrated deployment system and provision of spare parts and tools, and by a fault tree system which is customized for each aircraft. The responsiveness increases advantageously as a result, and the utilization of waiting times for maintenance, repair and overhaul work is improved.

The concept of the invention also includes a communication interface for the exchange of data between a log book provided on a vehicle and at least one terminal adapted for use in a system according to the invention and/or in a method according to the invention. In order that data can be exchanged, these are expressed in the form of text files in a markup language, in particular in an extensible markup language (XML), and/or communication is effected using interaction protocols, in particular, for communication among the terminals provided on the accessories. The communications interface is embodied, in particular, as a radio link and/or as an electronic data interface. Exchange protocols such as those defined by FIPA are preferably used for the negotiation components.

On the basis of the inventive concept, it is possible to specify, in developments of the invention, a promising system and method for planning and managing maintenance, repair and overhaul work on a vehicle of a transportation system comprising a network, said system and drawings also being described by way of example in the drawings. The method and system thus developed performs the planning and managing of maintenance, repair and overhaul work by the system. Advantageous developments of the invention are detailed in the dependent claims, which specify advantageous ways of realizing the concept explained above with regard to achieving the objects of the invention and with regard to other advantages.

It has found to be particularly advantageous when the transportation system network has a terminal provided on a component of the at least one vehicle, and the terminal is configured to transmit data defining accessory needs into the network. A component is understood here to be a component of an aircraft, such as an aircraft door or the like, that does not communicate with the log book. In this way, it is possible for components that are subsequently fitted to the aircraft to also be integrated within the system when maintenance, repair and overhaul work is being carried out. The terminal provided on the component is specifically prepared for the assignment of maintenance, repair and overhaul work to at least one first and/or second terminal provided on the accessories.

The method is particularly suitable for a network which has at least one third terminal assigned to the accessories. The accessories are selected from a group comprising spare parts, tools, transport devices and workers. In this way, it is possible, for example, for a first terminal to be on a worker, a second terminal on a tool and/or a transport device and a third terminal on a spare part, or for a first terminal to be provided on a tool and another first terminal to be provided on another tool.

The method is also suitable, in particular, for communication among the network components via a communications interface. The data are exchanged via the communications interface, in particular between a log book provided on a vehicle and at least one terminal. The communications interface is embodied, in particular, as a radio link and/or as an electronic data interface.

More particularly, a method is provided in which the data defining accessory needs are transformed into the log book provided on the vehicle from task schedules, in particular from maintenance, repair and overhaul schedules, and/or from monitoring sensors for monitoring components of the at least one vehicle.

More particularly, a method is provided in which the data defining accessory needs are received by a central system for presenting the data, for escalation management and/or for capacity and resource planning. Presentation of the data specifically includes an overview and detailed view of the status of all the vehicles in the transportation system, an overview and a detailed view of the maintenance, repair and overhaul tasks that are pending, in process and completed, an overview of the maintenance, repair and overhaul tasks that have not yet been negotiated conclusively among the network components, and an overview of schedule changes. In an escalation case, such presentation of the data advantageously allows tasks to be rearranged, capacities to be deployed and communication to be conducted for the planning of resources in the escalation management context. Capacity planning, in particular, is performed using a capacity planning tool which includes the steps of analysis and route assignment. The capacity planning tool specifically includes a task scheduler, a capacity planner, a rule system as the basis for decentralized negotiation among the separate network components, and a user interface.

It has been found particularly advantageous when the at least one first and second terminal capture measurement data and thus determine their positions by themselves. In the case of a query as to whether and where the accessories are located at a particular maintenance location, and are thus available for a unforeseen task, for example, the first and second terminal are able to give direct feedback.

Variants of the invention shall now be described with reference to the drawings and in comparison with the prior art, some of which is likewise shown. The drawings are not necessarily meant to show the variants to scale; rather, the drawings are provided in schematic form. It should be noted that many modifications and changes may be made to the shape and details of a variant, without deviating from the general idea of the invention. The features of the invention disclosed in the description, in the drawings and in the claims may be essential, both separately and in any combination, for development of the invention. In addition, all combinations of at least two of the features disclosed in the description, the drawings and/or the claims fall within the scope of the invention. The general idea of the invention is not limited to the exact shape or detail of the preferred variants shown and described in the following, nor is it limited to subject-matter that would be limited in comparison to the subject-matter in the claims. Further advantages, features and details of the invention derive from the following description of the preferred variants and with reference to the drawings, in which:

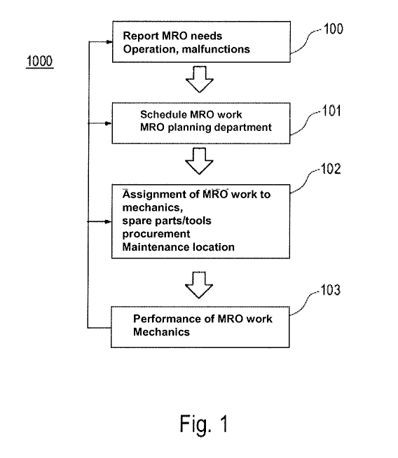

FIG. 1 shows a basic flow chart of a method 1000 for MRO planning and management;

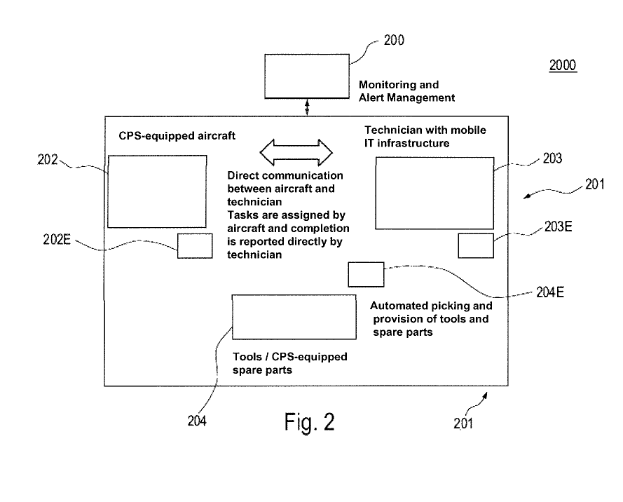

FIG. 2 shows a schematic diagram of a system, in this case a basic Cyber-Physical System (CPS), as a basis for planning and managing maintenance, repair and overhaul work according to a preferred variant of the invention;

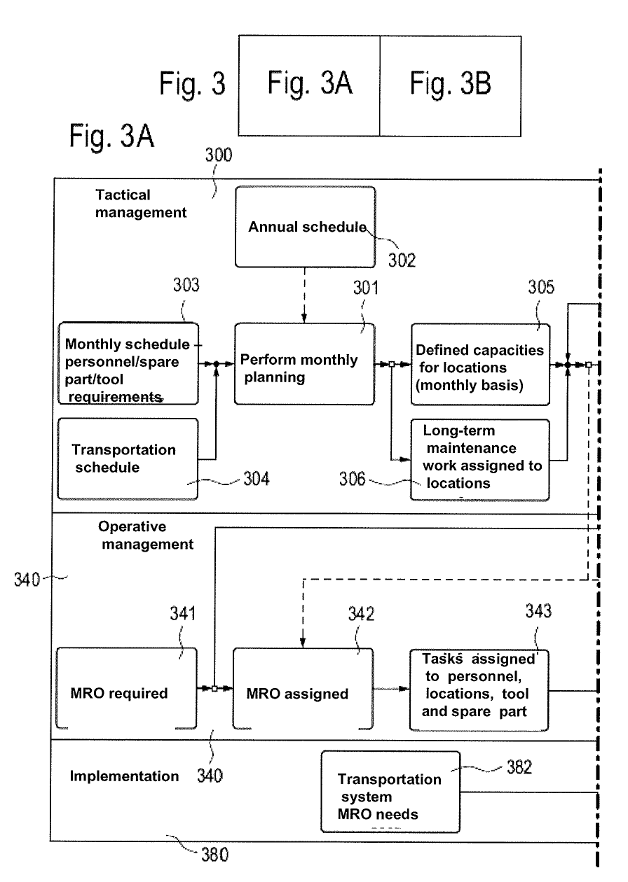

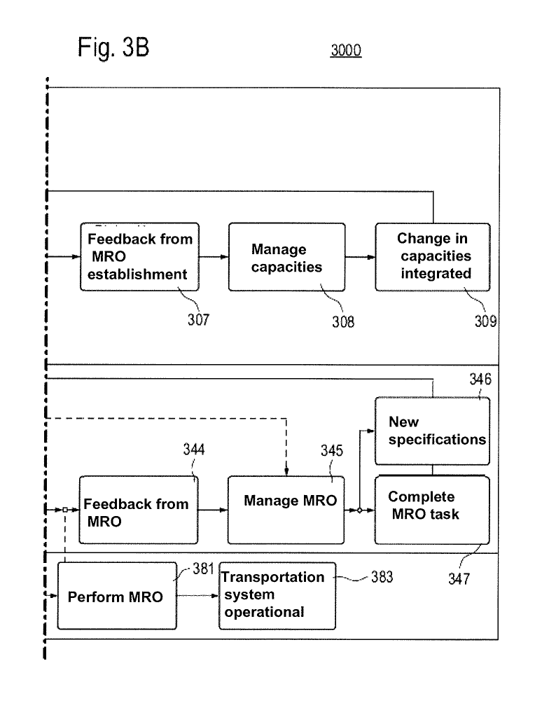

FIG. 3 shows a process design flow chart for decentralized planning and management of maintenance, repair and overhaul work, according to a preferred variant wherein, because of the size of the figure, the drawing of FIG. 3 is spread over two pages as FIGS. 3A and 3B with dotted lines representing where the separate figures are to be joined, 3A to 3B;

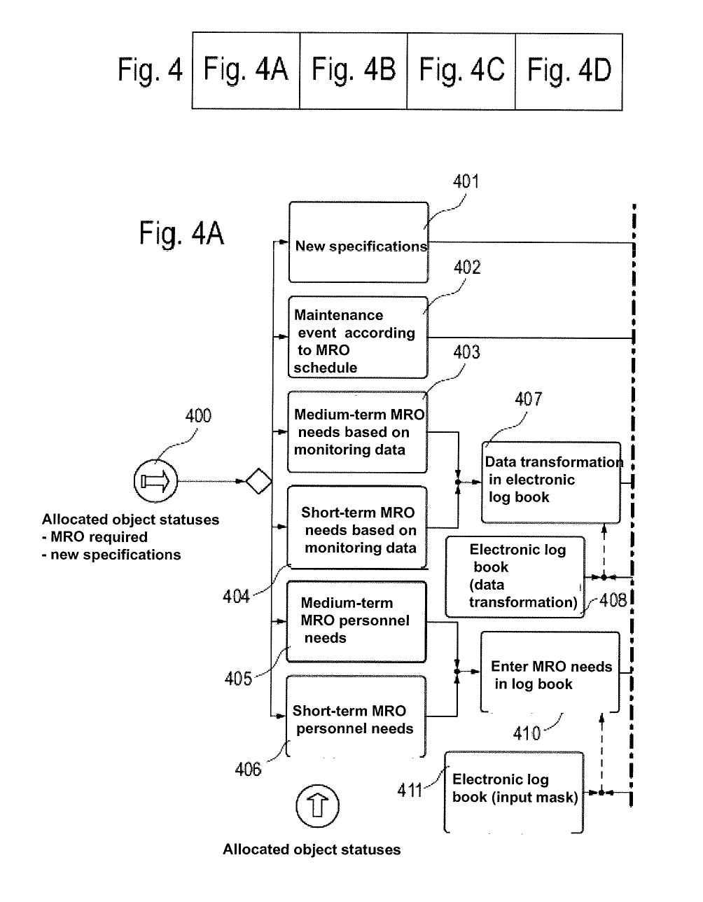

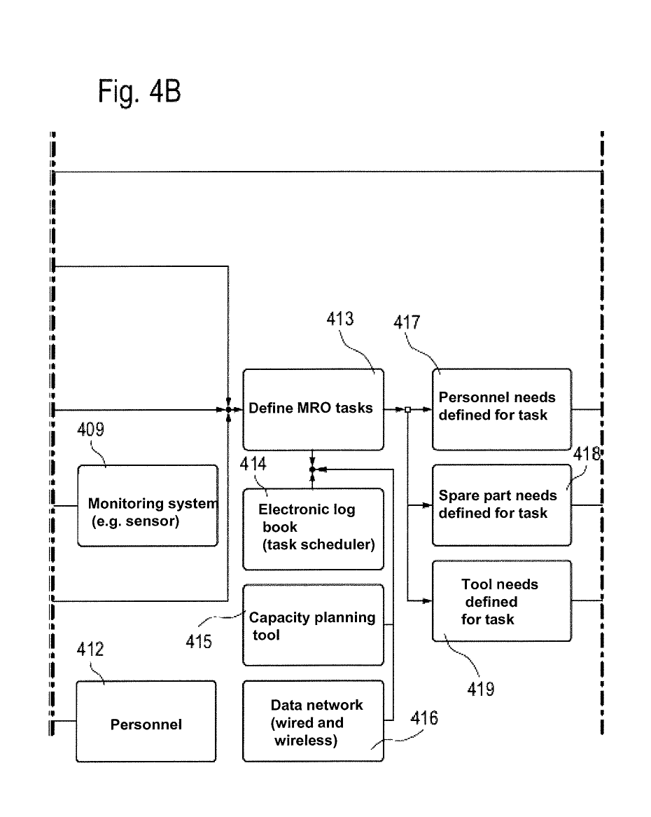

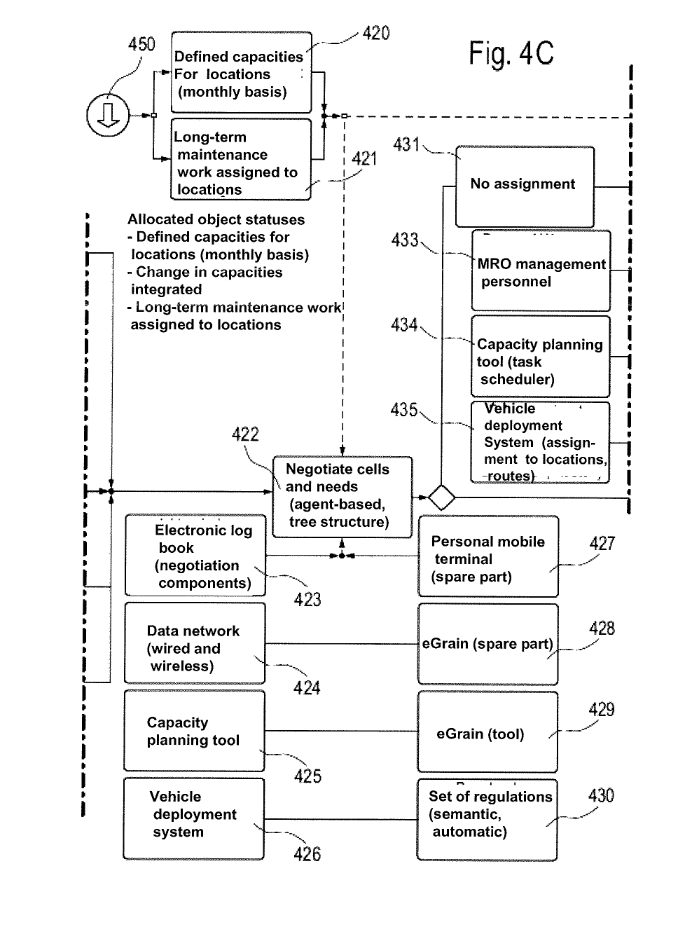

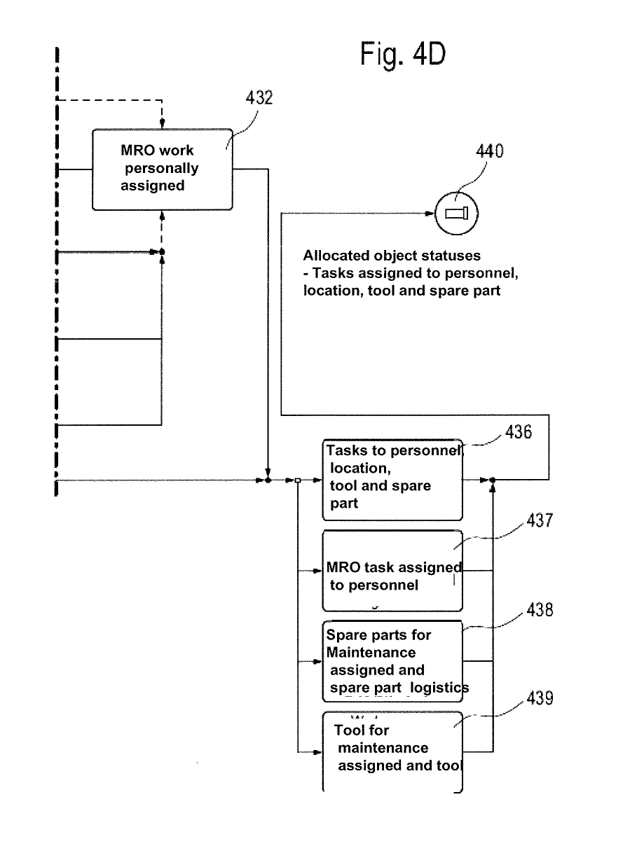

FIG. 4 shows a flow chart for a detailed process for assigning the maintenance, repair and overhaul tasks, according to a preferred variant wherein, because of the size of the figure, the drawing of FIG. 4 is spread over four pages as FIGS. 4A, 4B, 4C and 4D with dotted lines representing where the separate figures are to be joined, 4A to 4B to 4C to 4D;

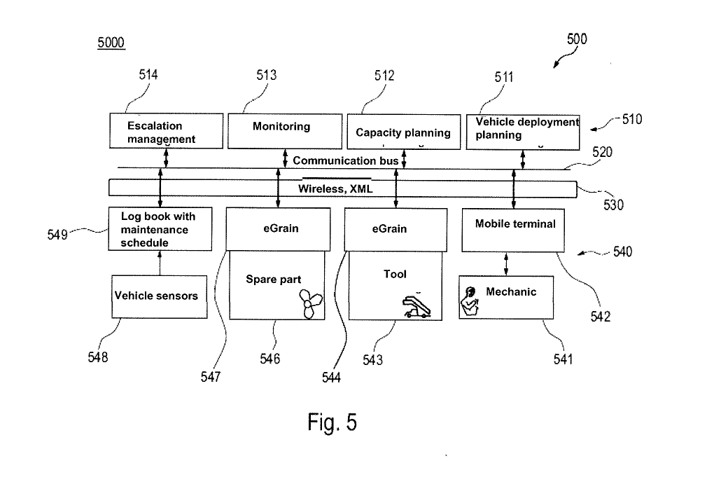

FIG. 5 shows another schematic diagram of a system for decentralized planning and management of maintenance, repair and overhaul work, according to a preferred variant.

FIG. 1 shows, by way of example, the basic principle of a method 1000 for planning and managing maintenance, repair and overhaul work, which is also abbreviated and referred to in FIG. 1 as MRO. The maintenance, repair and overhaul needs are reported in a first step 100. This includes general operations, i.e., predefined scheduled intervals for maintenance, repair and overhaul work, as well as unexpected disruptions that give rise to additional repair work. For the maintenance, repair and overhaul needs reported under step 100, the respective maintenance, repair and overhaul work is then scheduled in step 101 by a maintenance, repair and overhaul department. In step 102, the maintenance, repair and overhaul work is assigned by the latter department to the various accessories, such as the respective personnel, and to the procurement department for spare parts and tools. After this assignment, the maintenance, repair and overhaul work is carried out by the assigned personnel in step 103.

Such a method 1000 also has the disadvantage that it runs sequentially, which can therefore give rise to unnecessary idle times on the part of personnel, spare parts and tools. It also lacks flexibility and involves two interim steps, between reporting the maintenance, repair and overhaul needs in step 100 and performance of the maintenance, repair and overhaul work in step 103, which is disadvantageous for full capacity utilization in respect of accessories and the vehicles of a transportation system.

FIG. 2 shows the principle of a decentralized system 2000 for a CPS-based system for planning and managing maintenance, repair and overhaul work. This system is not tied to any sequential workflow, but rather may include parallel subprocesses, i.e., subprocesses that are independent of each other and/or which run contemporaneously with each other. In FIG. 2, a CPS 201 is connected to a monitoring and alert management system 200. The monitoring and alert management system 200 is adapted to regulate the basic capacity planning system centrally for all the vehicles in the respective transportation system and thus forms the basis for planning and management. CPS 201 provides a CPSequipped aircraft 202 as an example of a vehicle and a member of personnel 203 equipped with a mobile terminal. Aircraft 202 equipped with an electronic network-ready log book 202E is in direct communication with the member of personnel 203 (or similar person performing maintenance work) equipped with a terminal 203E, as indicated by a double-headed arrow in FIG. 2. In contrast to the prior art, the maintenance, repair and overhaul tasks are thus assigned directly by aircraft 202 to personnel 203 via devices 202E, 203E, and completion of the tasks is reported directly from mobile terminal 203E of personnel 203 to aircraft 202 and its log book 202E. CPS 201 also provides tools, transporter units and spare parts 204, which are equipped with CPS, and thus likewise have a terminal 204E. Due to the latter being equipped with CPS, the tools, transporter units and spare parts 204 are automatically picked and provided. This principle shortens the task workflow and the number of administrative steps involved. Personnel 203 can be commissioned directly in real time by aircraft 202. This is supported by an integrated deployment system and provision of spare parts, transport units and tools 204, and/or by a fault tree system which is customized for each aircraft. As a result, responsiveness in maintenance, repair and overhaul field is enhanced and the idle times of aircraft can be shortened by additional work. Waiting times, for example for spare parts or tools, are also reduced.

FIG. 3 shows a process design for a method method 3000 for decentralized planning and management of maintenance, repair and overhaul work. This system is not tied to any sequential workflow, but rather may include parallel subprocesses, i.e., subprocesses that are independent of each other and/or which run contemporaneously with each other. The process design includes tactical management 300, operative management 340 and implementation structure 380, tactical management 300 being connected to operative management 340 and operative management 340 being connected to implementation structure 380 via interfaces. Monthly scheduling is provided as part of tactical management 300. To perform monthly scheduling in step 301, annual schedule 302, monthly schedule 303 with requirements in respect of personnel, spare parts and tools, and transportation schedule 304 are taken into consideration. In the monthly scheduling carried out in step 301, capacities for the maintenance locations are defined each month in step 305, and long-term maintenance tasks are assigned to the maintenance locations in step 306. The information is processed not only within tactical management 300, but also in operative management 340. In tactical management 300, the information is forwarded to the respective maintenance, repair and overhaul establishment in step 307, which provides feedback in that respect. The capacities are then managed in step 308 and any changes in capacity are integrated into the schedule in step 309. When the change in capacity has been integrated in the schedule in step 309, a new comparison is made between the capacities defined in step 305 for the maintenance locations and the long-term maintenance tasks assigned to the maintenance locations. Steps 307, 308 and/or 309 are then performed again, or several times if necessary.

The information is likewise forwarded to operative management 340. It flows, in particular, into the maintenance, repair and overhaul assignments in step 342 and into the maintenance, repair and overhaul management in step 345. Operative management 340 is initiated by an input signal indicating when the maintenance, repair and overhaul work as defined in step 341 is required. The maintenance, repair and overhaul work is assigned in step 342 on the basis of this information and any new specifications arising from step 346.

The tasks are distributed among the personnel, the maintenance locations, the tools and the spare parts in step 343. Feedback from the maintenance, repair and overhaul work in response to this information is awaited in step 344, and the information is forwarded to implementation structure 380. Either this information leads to feedback from the maintenance, repair and overhaul work in step 344, on the basis of which the maintenance, repair and overhaul work is then managed in step 345, and as a result the maintenance, repair and overhaul tasks are completed in step 347, or a new specification in step 346 leads to a new assignment of maintenance, repair and overhaul work in step 342, or the information leads to maintenance, repair and overhaul work being performed in step 381. In addition to the information from operative management 340, information about the maintenance, repair and overhaul needs of the transportation system are also received from step 382 in order to carry out the maintenance, repair and overhaul work in step 381. Once the maintenance, repair and overhaul work has been carried out in step 381, the transportation system is reported as operational in step 383.

FIG. 4 shows a method 4000 for a detailed process of assigning the maintenance, repair and overhaul tasks. Assignment is carried out in accordance with the basic concept by means of an electronic log book of a vehicle of the transportation system and/or by means of at least one terminal provided on an accessory. In a first step 400, the electronic log book 202E indicated whether and which maintenance, repair and overhaul work scheduled on a long-term and/or daily basis is required and whether new specifications as a result of disruptions or malfunctions can be taken into consideration. Such an electronic log book is provided so that it can determine its own position, to establish a radio communication link and/or as a means of transforming data. It also has a fault tree system, an electronic data interface such as XML or FIPA, a user interface such as an input mask and/or a task scheduler.

Via a data interface, the data displayed in the first step 400 are subdivided for further processing into the following steps: new specifications in step 401, result of maintenance work according to the maintenance schedule in step 402, medium-term repair needs based on monitoring data in step 403, short-term repair needs based on the monitoring data in step 404, medium-term repair needs by personnel in step 405 and short-term repair needs by personnel in step 406.

The monitoring data are collated from steps 403 and 404 and transformed in a further step 407 into the electronic log book 202E. The data from a monitoring system 409, and the data transformation into electronic log book 202E are combined in step 408. Monitoring system 409 includes, for example, sensors for detecting the status of a vehicle component, and a radio communication link with the log book, for reporting the component status to the latter.

Repair needs 405, 406 are collated by personnel and entered as maintenance needs into log book 202E in a further step 410. Personnel needs 412 are combined with log book 202E via an input mask 411 of the electronic log book and are entered as maintenance needs into the log book in step 410.

The result of maintenance work according to maintenance schedule 402, the data transformation into the electronic log book in step 407, and the maintenance needs entered into the log book in step 410 are collated. In a next step 413, the maintenance, repair and overhaul tasks are defined on that basis. In further steps after the definition of maintenance, repair and overhaul tasks, personnel needs are defined in step 417, spare parts needs in step 418 and tool needs in step 419, for the respective task or tasks. These data are combined with the new specifications in a further step 401. With the aid of these combined data and other data, the times and needs are negotiated among the devices involved. Further data include the definition of capacities for the individual maintenance locations in step 420, and assignment of the long-term maintenance tasks to the maintenance locations in step 421.

Further data are collated from the electronic log book in step 423, which operates independently as a negotiating component, i.e. on the system side, from the data network in step 424, such as cable and wireless communication, from a capacity planning tool in step 425, a vehicle deployment system in step 426, from a mobile terminal provided in the form of an eGrain on a spare part, in step 427, from a terminal provided in the form of an eGrain on a spare part, in step 428, from a terminal provided in the form of an eGrain on a tool, in step 429, and from a set of regulations in step 430.

The negotiations are conducted, for example, among eGrains 428, 429, and the result is then forwarded directly from the eGrains to electronic log book 202E in step 423. Multiple feedback to a central system thus becomes superfluous, and the number of loops required is reduced. The electronic log book 202E is stored in step 423, and the data are preferably given a tree structure. A plurality of similar objects can thus be chained to each other such that the otherwise linear structure of the data is broken, with branching occurring as a result.

The data from the set of regulations are preferably processed semantically and/or automatically, i.e., in such a way that the respective data are given a unique description and can thus be further processed by the system and/or automatically.

If the negotiations were successful, various assignments are made by the system. These include: in a first step 436, the assignment of tasks to the personnel, the maintenance locations, the tool and/or the spare parts, in a further step 437 the assignment of maintenance, repair and overhaul work to the personnel, in a further step 438 the assignment of the respective spare parts for maintenance via the spare parts logistics system, and in yet another step 439, the assignment of the tools for maintenance. Due to these assignments, all the tasks to be performed and the requisite accessories are assigned in step 440, and the respective maintenance, repair and overhaul tasks can be performed.

If the negotiations in step 422 were not successful, no assignment is performed in step 431, first of all. With the aid of data collated from steps 420 and 421, collated data about personnel in maintenance, repair and overhaul management in step 433, and from a capacity planning tool in step 434—such as a task scheduler and a vehicle deployment system, for example, by means of which vehicles are assigned to the maintenance locations according to the vehicle's routes—the maintenance, repair and overhaul work is personally assigned in step 432 and combined with the negotiation data from step 422. Here, too, steps 436 to 440 described above are performed.

FIG. 5 shows a system architecture 500 for a system 5000 for decentralized planning and managing of maintenance, repair and overhaul work. This system is not tied to any sequential workflow, but rather may include parallel subprocesses, i.e., subprocesses that are independent of each other and/or which run contemporaneously with each other. System architecture 500 has a centralized system 510 and a decentralized system 540, which are connected to each other via a communication station 520—in this case wirelessly in XML format via an interface 530. The centralized system 510 has a resource planning system 511 for scheduling deployment of the respective vehicles, a capacity planning system 512, a monitoring system 513 and an escalation management system 514. The decentralized system 540 has a mechanic 541 with a mobile terminal 542, e.g., in the form of an eGrain, a tool and/or transport device 543 provided with a terminal in the form of an eGrain 544, a spare part 546 provided with a further terminal in the form of an eGrain 547, and a log book 549 with a maintenance schedule. Log book 549 is connected wirelessly or by wire to sensors 548 in the vehicle. The decentralized system 540 transmits data wirelessly in XML format via an interface 530 to communication station 520.

The decentralized system 540 thus allocates the individual tasks of long-term maintenance work to daily maintenance work in a flexible manner, according to the time slots in which the vehicles stop at the maintenance locations. This reduces the idle times of the transportation systems in connection with major maintenance tasks. The individual tasks are assigned decentrally by the system and/or automatically. Manual intervention is essentially only provided for capacity planning 512 and escalation management 514.

### LIST OF REFERENCE SIGNS

100 Maintenance, repair and overhaul needs
101 Maintenance, repair and overhaul work
102 Procurement of spare parts and tools
103, 203, 406 Assigned personnel
200 Surveillance and alert management
201 CPS (Cyber-Physical System)
202 Aircraft
202E, 549 Electronic log book
203E, 204E, 542 Mobile terminal
300 Tactical management
301 Monthly schedule
302 Annual schedule
304 Transport schedule
305, 306, 420, 421 Maintenance locations
307 Maintenance, repair and overhaul operations
308 Capacity
309 Change in capacity
340 Operative management
341, 342, 344, 381 Repair and maintenance
342 Repair assignment
345, 433 Management of maintenance, repair and overhaul work
347 Maintenance, repair and overhaul task
380 Implementation structure
382 Transportation system
402 Maintenance schedule
403, 404 Surveillance data
405, 406 Repair needs
408 Data transformation
409 Surveillance system
410 Maintenance needs
412, 417 Personnel needs
418 Individual requirement
419 Tool needs
422 Negotiations
423 Negotiating component
424 Data network
425, 434 Capacity planning tool
426 Vehicle deployment system
427, 428, 429, 544, 547 eGrain
430 Body of regulations
436 Assignment of tasks to personnel
437 Assignment of the maintenance, repair and overhaul task
438 Assignment of the respective spare parts
439 Assignment of the tools for maintenance
440 Accessory
500 System architecture
510 Central system
511 Resource planning
512 Capacity planning
513 Monitoring
514 Escalation management
520 Communication bus
530 Interface
540 Decentralized system
541 Mechanic
543 Transport device
1000, 3000, 4000 Method
2000, 5000 System

1. A method for planning and managing maintenance, repair and over-haul work on a vehicle of a transportation system comprising a network which includes the following network components:
at least one vehicle,
a log book assigned to the at least one vehicle, in particular an electronic network-ready log book,
accessories, in particular with assignment to a maintenance location,
at least one first terminal assigned to the accessories,
at least one second terminal assigned to the accessories,
said method comprising the steps of:
a) transmitting data defining accessory needs from the log book into the network,
b) receiving the data at the first and the second terminal,
c) bidirectional communication among the network components,
d) assigning the maintenance, repair and overhaul work,
e) providing feedback after completion of the maintenance, repair and overhaul work,
wherein said assigning and said providing of feedback are performed by at least one of the network components.

2. The method according to claim 1, characterized in that the transportation system network has a terminal provided on a component of the at least one vehicle and the terminal is configured to transmit data defining accessory needs into the network.

3. The method according to claim 1, characterized in that the network has at least one third terminal assigned to the accessories, said terminal being specifically assigned to a person performing maintenance work, in particular to a worker.

4. The method according to claim 1, characterized in that bidirectional communication includes negotiation among the network components, and further comprising the step of
c′) alert management when said bidirectional negotiation is unsuccessful.

5. The method according to claim 1, characterized in that steps a) to e), including step c′) in particular, are performed via a communications interface, in particular in that the steps are performed sequentially, preferably in a loop.

6. The method according to claim 1, characterized in that the data defining accessory needs are transformed into the log book provided on the vehicle from task schedules, in particular from maintenance, repair and overhaul schedules, and/or from monitoring sensors for monitoring components of the at least one vehicle.

7. The method according to claim 1, characterized in that the data defining accessory needs are received by a central system for presenting the data, for escalation management and/or for capacity and resource planning.

8. The method according to claim 1, characterized in that the at least one first and second terminal capture measurement data and thus determine their positions by themselves.

9. A computer software product for planning and managing maintenance, repair and overhaul work for transportation systems comprising a network which includes the following network components:
at least one vehicle,
a log book assigned to the at least one vehicle,
accessories, in particular with assignment to a maintenance location,
at least one first terminal assigned to the accessories,
at least one second terminal assigned to the accessories,
the computer software product being designed to be loaded into a storage unit of at least one network component and having portions of software code,
by means of which the computer software product is designed to perform the steps of the method according to claim 1 when it runs on a processing unit of the network component.

10. A digital storage medium, in particular an electronic, optical and/or magnetic storage medium containing electronically readable computer-implemented instructions which can interact with a programmable computer system in such a way that the method according to claim 1 is performed.

11. A terminal, designed for being attached to accessories of a transportation system comprising a network, wherein the terminal is provided as a component of the network, said terminal comprising:
an input channel for receiving information,
an output channel for transmitting a control signal,
a storage unit for storing the information,
a processing unit for processing the computer software product according to claim 9, and
a communications protocol for defining the syntax, the semantics and/or the synchronization of communication with other network components,
wherein the terminal is configured for bidirectional communication with the other network components.

12. The terminal according to claim 1, comprising a highly miniaturized computer and/or an RFID system.

13. A system for planning and managing maintenance, repair and over-haul work on a vehicle of a transportation system comprising a network, the former system comprising:
a central system for presenting the data, for escalation management and/or for capacity and resource planning,
network components of the transportation system network, including:
at least one vehicle,
a log book assigned to the at least one vehicle,
accessories,
at least one first terminal provided on the accessories,
at least one second terminal provided on the accessories,
a communications interface for exchanging data between the central system and the network components, at least,
wherein at least one of the network components is configured to assign the maintenance, repair and overhaul work and to provide feedback after completion of the maintenance, repair and overhaul work.

14. The system for planning and managing maintenance, repair and overhaul work according to claim 13, characterized in that at least the first and second terminals are configured to communicate with each other via the communications interface.

15. The system for planning and managing maintenance, repair and overhaul work according to claim 13, characterized in that the network components of the transportation system network further include:
at least one defined maintenance location with certified maintenance scope and/or maintenance capacity; and/or
a person performing maintenance work, having predefined maintenance skills and/or maintenance capacity and assigned in particular to a maintenance location.

16. The system according to claim 12, characterized in that the accessories are tools, transporter units, spare parts and/or persons performing maintenance work, in particular workers.

17. The system according to claim 12, characterized in that the first terminal is assigned to a tool and/or that a further first terminal is assigned to a transporter unit and/or that the second terminal is assigned to a spare part and/or that a third terminal is assigned to a person performing maintenance work, in particular to a worker.

18. A communications interface for exchanging data between a log book provided on a vehicle and at least one terminal adapted for use in the system according to claim 13 and/or in the method according to claim 1.

19. The method according to claim 1, characterized in that:
the transportation system network has a terminal provided on a component of the at least one vehicle and the terminal is configured to transmit data defining accessory needs into the network;
the network has at least one third terminal assigned to the accessories, said terminal being specifically assigned to a person performing maintenance work, in particular to a worker;
bidirectional communication includes negotiation among the network components, and further comprising the step of c′) alert management when said bidirectional negotiation is unsuccessful;
steps a) to e), including step c′) in particular, are performed via a communications interface, in particular in that the steps are performed sequentially, preferably in a loop;
the data defining accessory needs are transformed into the log book provided on the vehicle from task schedules, in particular from maintenance, repair and overhaul schedules, and/or from monitoring sensors for monitoring components of the at least one vehicle;
the data defining accessory needs are received by a central system for presenting the data, for escalation management and/or for capacity and resource planning; and
the at least one first and second terminal capture measurement data and thus determine their positions by themselves.

20. A computer software product for planning and managing maintenance, repair and overhaul work for transportation systems comprising a network which includes the following network components:
at least one vehicle,
a log book assigned to the at least one vehicle,
accessories, in particular with assignment to a maintenance location,
at least one first terminal assigned to the accessories,
at least one second terminal assigned to the accessories,
the computer software product being designed to be loaded into a storage unit of at least one network component and having portions of software code,
by means of which the computer software product is designed to perform the steps of the method according to claim 19 when it runs on a processing unit of the network component.

21. A digital storage medium, in particular an electronic, optical and/or magnetic storage medium containing electronically readable computer-implemented instructions which can interact with a programmable computer system in such a way that the method according to claim 19 is performed.

22. The system for planning and managing maintenance, repair and overhaul work according to claim 13, characterized in that:
at least the first and second terminals are configured to communicate with each other via the communications interface;
the network components of the transportation system network further include:
at least one defined maintenance location with certified maintenance scope and/or maintenance capacity; and/or
a person performing maintenance work, having predefined maintenance skills and/or maintenance capacity and assigned in particular to a maintenance location;
the accessories are tools, transporter units, spare parts and/or persons performing maintenance work, in particular workers; and
the first terminal is assigned to a tool and/or that a further first terminal is assigned to a transporter unit and/or that the second terminal is assigned to a spare part and/or that a third terminal is assigned to a person performing maintenance work, in particular to a worker.

23. A communications interface for exchanging data between a log book provided on a vehicle and at least one terminal adapted for use in the system according to claim 13 and/or in the method according to claim 19.
